(19) United States
(12) Patent Application Publication
(10) Pub. No.: US 2017/0147393 A1
(43) Pub. Date: May 25, 2017

(54) CACHE-EFFICIENT SYSTEM FOR TWO-PHASE PROCESSING

(71) Applicant: SAP SE, Walldorf (DE)

(72) Inventors: Kai Stammerjohann, Wiesloch (DE); Nico Bohnsack, Ingersleben (DE); Frederik Transier, Heidelberg (DE)

(21) Appl. No.: 14/947,689

(22) Filed: Nov. 20, 2015

(51) Int. Cl. G06F 9/46; G06F 3/06; G06F 17/30

(52) U.S. Cl. CPC G06F 9/467; G06F 17/30339; G06F 3/0604; G06F 3/0644; G06F 3/067

(57) ABSTRACT

A system provides determination of a first plurality of the plurality of data records assigned to a first processing unit, identification of a first record of the first plurality of data records, the first record associated with a first key value, determination of a first partition based on the first key value, allocation of a first memory block associated with the first partition, the first memory block comprising a first two or more memory locations, generation of a mapping between the first record and a first one of the first two or more memory locations, identification of a second record of the first plurality of data records, the second record associated with a second key value, determination of the first partition based on the second key value, and generation of a mapping between the second record and a second one of the first two or more memory locations.

### BACKGROUND

Some computing environments provide parallel processing and shared memory. These features may be leveraged by processing large data sets in two distinct phases. During a first (“working”) phase, a set of records is split into smaller working packages. The working packages are processed by execution units (e.g., “threads”) independently and in parallel to generate intermediate results, and each intermediate result is associated with a partition. Next, in a second (“merging”) phase, the intermediate results of each partition are merged by execution units which are dedicated to the various partitions.

In some working phases, records having a same key value are processed in order to generate a single result associated with the key value. For examples, a key value may be a date, each record may represent a sale occurring on a particular date, and the single results may comprise totals of all sales on each date. It is therefore desirable to identify records associated with identical key values and to associate each record having a particular key value with a particular result slot (i.e., memory location).

FIG. 1 illustrates an example of the above-described associations. For simplicity, each of records 100 is represented solely by its key value. During the working phase, records 100 are traversed to initialize a result slot 150 for each key value. A result slot 150a is initialized for the first record associated with key value A, a result slot 150b is initialized for the second record associated with key value B, and a result slot 150c is initialized for the third record associated with key value C. Each result slot 150 is associated with a particular partition based on the key value and a specified criterion.

The fourth record is associated with key value A and no result slot 150 is initialized therefor because a result slot 150a has already been initialized for key value A. Once all records 100 have been traversed, each of records 100 is mapped to the result slot 150 associated with its key value. The desired operations are then applied to each record, wherein the mapping is applied separately to each operation to allow cache-local execution.

Since the records may be randomly distributed within the working packages, the memory locations of intermediate results associated with one partition are typically interleaved with memory locations of intermediate results associated with other partitions, as shown in FIG. 1. As a result, the intermediate results are unfavorably arranged for retrieval by partition-specific processing units in the merging phase.

### BRIEF DESCRIPTION OF THE DRAWINGS

FIG. 1 illustrates a method to allocate memory locations for storing computed values.

FIG. 2 is a block diagram of a system according to some embodiments.

FIG. 3 is a tabular representation of a portion of a database table according to some embodiments.

FIG. 4 is a flow diagram according to some embodiments.

FIGS. 5A through 5J illustrate the allocation of memory locations according to some embodiments.

FIG. 6 is a flow diagram according to some embodiments.

FIG. 7 illustrates result merging according to some embodiments.

FIG. 8 is a block diagram of an apparatus according to some embodiments.

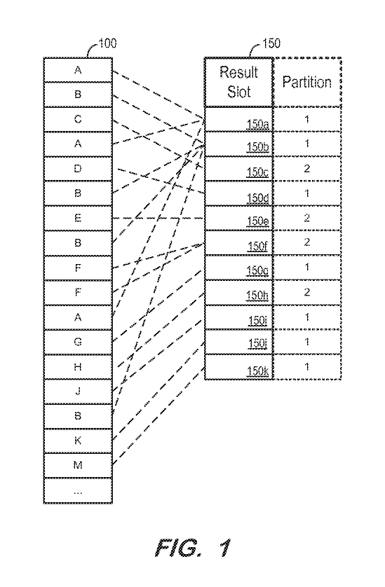

### DETAILED DESCRIPTION

The following description is provided to enable any person in the art to make and use the described embodiments. Various modifications, however, will remain readily apparent to those in the art.

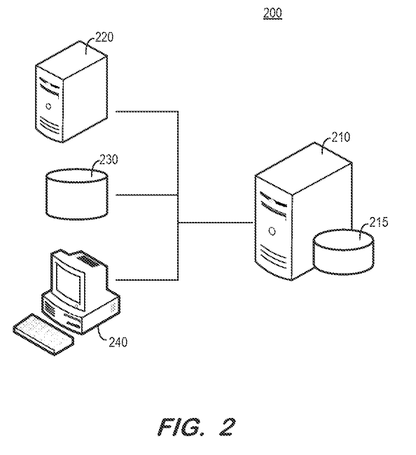

FIG. 2 is a block diagram of system 200. Any of the depicted elements of system 200 may be implemented by one or more hardware devices coupled via any number of public and/or private networks. Two or more of such devices may be located remote from one another, and all devices may communicate with one another via any known manner of network(s) and/or via a dedicated connection. Embodiments are not limited to the architecture of system 200.

Server 210 may comprise a hardware server for managing data stored in database 215. In some embodiments, server 210 executes processor-executable program code of a database management system to store data to and retrieve data from database 215. Server 210 may provide alternative or additional services, including but not limited to the methods described herein, query processing, business applications, Web hosting, etc.

Database 215 may be implemented in Random Access Memory (e.g., cache memory for storing recently-used data) and one or more fixed disks (e.g., persistent memory for storing their respective portions of the full database). Alternatively, database 215 may implement an “in-memory” database, in which volatile (e.g., non-disk-based) memory (e.g., Random Access Memory) is used both for cache memory and for storing the full database. In some embodiments, the data of database 215 may comprise one or more of conventional tabular data, row-based data, column-based data, and object-based data. Database 215 may also or alternatively support multi-tenancy by providing multiple logical database systems which are programmatically isolated from one another.

According to system 200, server 210 may receive data from server 220, data warehouse 230 and/or desktop computer 240 for storage within database 215. Server 220, data warehouse 230 and desktop computer 240 are illustrated merely to provide examples of the type of systems from which server 210 may receive data. Generally, data may be received from any type of hardware over any one or more communication networks.

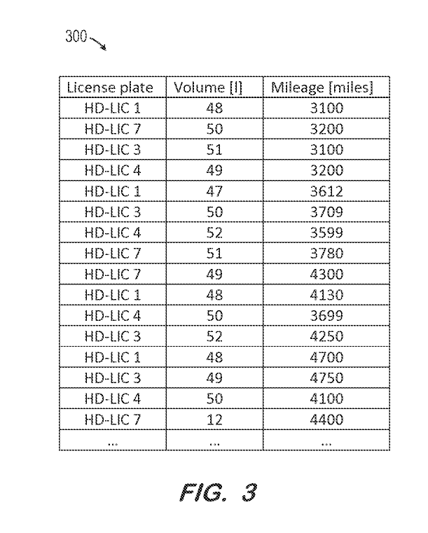

FIG. 3 includes a representation of table 300 for purposes of describing processes according to some embodiments. Each record of table 300 corresponds to a fuel purchase using a same credit card. After each purchase, a record is created including the license plate number of the vehicle for which the fuel was purchased, the volume of fuel purchased, and the odometer reading of the vehicle at the time of purchase. Of course, table 300 may include additional fields, including but not limited to a transaction date, a price paid, and an identifier of the gas station at which the purchase was made. With reference to system 200, the data of table 300 may have been received by server 210 from any of devices 220-240 and stored in database 215 as illustrated in FIG. 3.

Some embodiments may operate to efficiently process each record of table 300 and to store the results associated with each license plate number in a respective memory location in a cache-efficient format. Some embodiments perform such processing using operations executed in parallel. Accordingly, some embodiments may be particularly suited for execution using multiple processing units. A processing unit as described herein may comprise any processing entity capable of operating in parallel with other processing entities. Examples of processing units include but are not limited to threads, processor cores, and processors.

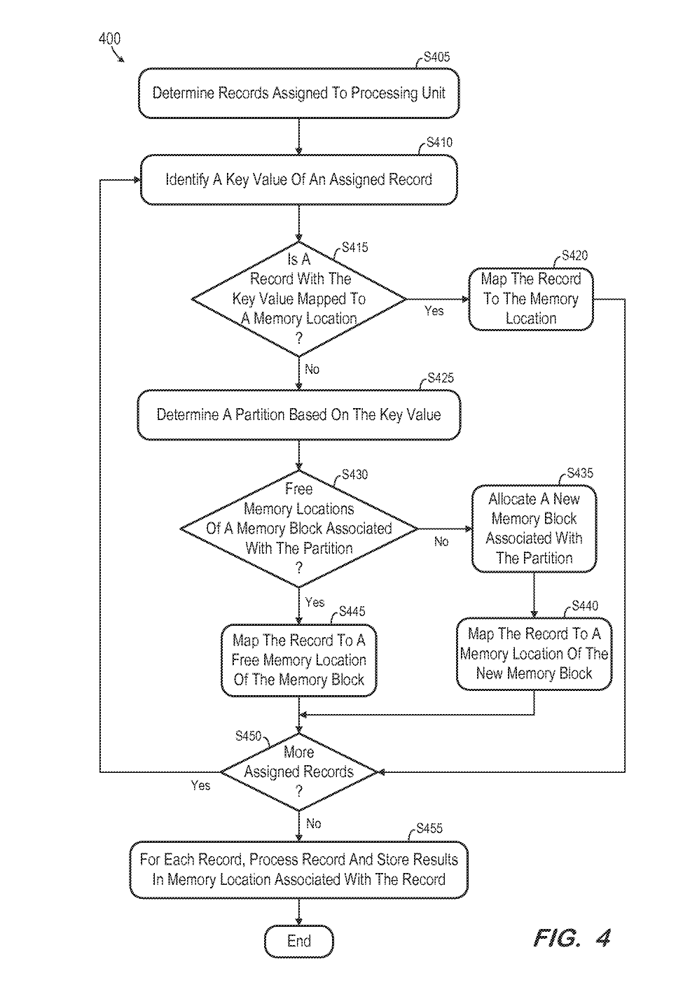

FIG. 4 comprises a flow diagram of process 400 according to some embodiments. Process 400 may be executed by a processing unit of server 210 according to some embodiments. Process 400 and all other processes mentioned herein may be embodied in computer-executable program code read from one or more non-transitory computer-readable media, such as a floppy disk, a CD-ROM, a DVD-ROM, a Flash drive, a fixed disk and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

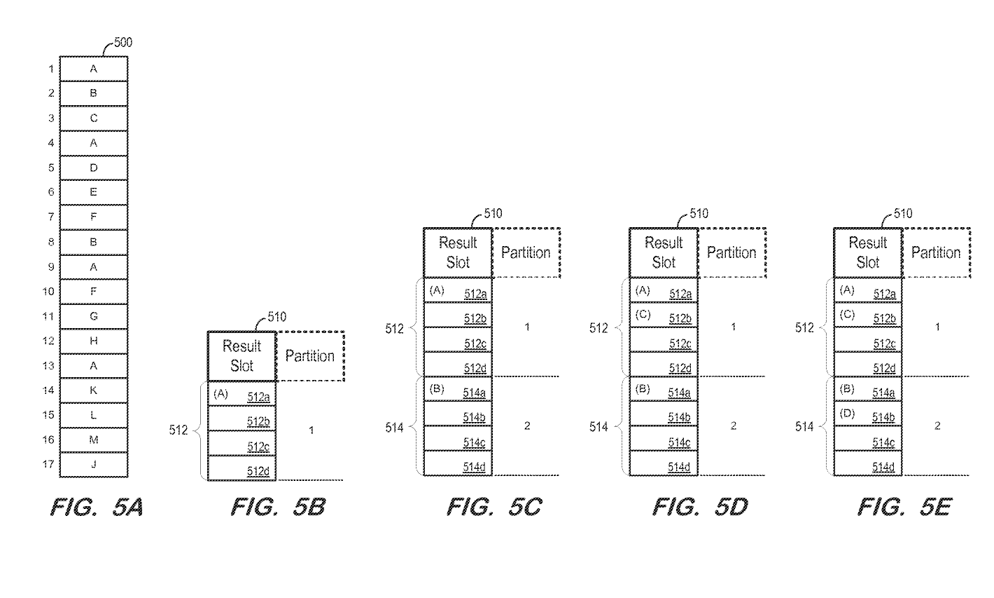

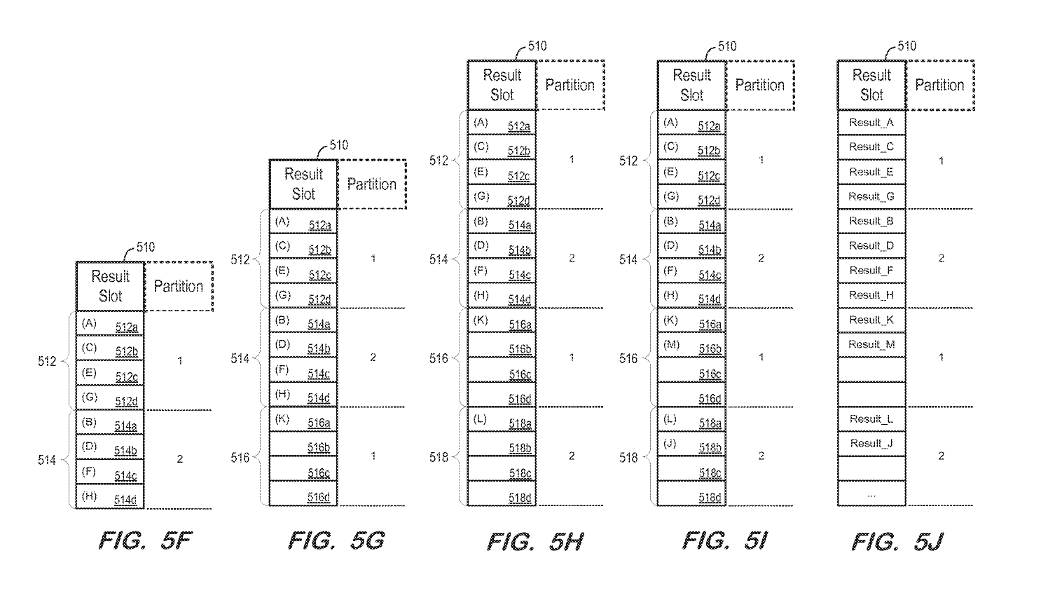

Prior to S405, various records of a database table are assigned to respective ones of two or more processing units. For example, FIG. 5a shows a representation of records 500, where each record is represented solely by its key value for clarity. Records 500 are assigned to a single execution thread. Records 500 may comprise a portion of a larger database table, where other records of the database table are assigned to other respective execution threads. According to some embodiments, each such execution thread unit executes process 400 on its assigned records independently and in parallel. As will be understood, such processing may produce cache-efficient intermediate results.

At S405, a processing unit determines the records which have been assigned to it. For example, an execution thread of the present example determines that records 500 have been assigned to it. Next, at S410, a key value of a first assigned record is identified. Continuing with the present example, the execution thread identifies the key value “A” in Record 1 of assigned records 500.

Next, at S415, it is determined whether a record having the key value has been mapped to a result slot (i.e., a memory location for storing intermediate results). No mappings have been established at this point of the example, so flow proceeds to S425. A partition is determined at S425 based on the key value.

Any criteria may be used to determine a partition based on a key value. For example, in a case that the key values are dates, then records having key values within a first time period may be assigned to a first partition, records having key values within a second time period may be assigned to a second partition, records having key values within a third time period may be assigned to a third partition, and so on.

In the present example, it will be assumed that records having a key value of “A” are assigned to Partition 1. At S430, it is determined whether free memory locations of a memory block associated with the partition exist. No memory locations have been allocated at this point of process 400 and therefore no free memory locations exist. Consequently, flow proceeds to S435.

A new memory block associated with the partition is allocated at S435. FIG. 5B represents memory area 510 including memory block 512 allocated at S435 according to some embodiments. Memory area 510 may be a portion of a cache memory which is, exclusively or non-exclusively, accessible to the current execution thread. Memory block 512 includes four result slots 512a-512d. As illustrated in FIG. 5B, memory block 512 and each of its constituent result slots are associated with Partition 1.

The current record is mapped to a memory location of the new memory block at S440. For example, a mapping is created between Record 1 and memory location 512a. The indication “(A)” in FIG. 5B is intended to represent this mapping—no data is necessarily stored in memory location 512a at this point of process 400.

It is determined at S450 whether more records are assigned to the processing unit. If so, flow returns to S410. Again, a key value of a record is identified at S410. Continuing the present example, the key value “B” of Record 2 is identified at S410, and it is determined at S415 that no record having the key value is mapped to a memory location.

In the present example, it is determined at S425 that the key value “B” is associated with Partition 2. Embodiments are not limited to the determination of a Partition which is different from the previously-determined Partition. That is, the key value “B” may be determined to be associated with Partition 1 in some examples.

At S430, it is determined that no free memory locations of a memory block associated with Partition 2 exist. Accordingly, a new memory block associated with Partition 2 is allocated at S435. FIG. 5C represents memory block 514 of memory area 510, which is allocated at S435 according to some embodiments. Memory block 514 includes four result slots 514a-514d. As illustrated in FIG. 5C, memory block 512 and each of its result slots are associated with Partition 2.

Embodiments are not limited to four result slots per memory block, nor to an equal number of result slots per memory block. Embodiments are also not limited to equally-sized memory blocks.

Record 2 is mapped to memory location 514a at S440, by creating a mapping between Record 2 and memory location 514a. Again, the indication “(B)” in FIG. 5C is intended to represent this mapping, and not to represent any particular data stored in memory location 514a.

Flow returns to S410 to identify the key value “C” of Record 3, and it is again determined at S415 that no record having this key value is mapped to a memory location. According to the present example, it is determined at S425 that the key value “C” is associated with Partition 1. At S430, it is determined that memory block 512 is associated with Partition 1 and that memory locations 512b-512d of memory block 512 are free. Accordingly, as shown in FIG. 5D, Record 3 is mapped to memory location 512b at S445, by creating a mapping between Record 3 and memory location 512b.

Flow returns to S410 to identify the key value “A” of Record 4. It is then determined at S415 that a record having this key value (i.e., Record 1) has been mapped to a memory location (i.e., location 512a). Accordingly, at S420, a mapping is generated to map Record 4 to location 512a.

Flow proceeds through S450 and returns to S410 to identify the key value “D” of Record 5. Flow then continues as described above with respect to Record 3 to map Record 5 to memory location 514b at S445, as shown in FIG. 5E.

Flow continues as described above with respect to Records 6 through 13 to map each of these records to various ones of locations 512a-512d and 514a-514d, as depicted in FIG. 5F. During processing of Record 14, it is determined at S425 that Partition 1 is associated with the key value K and, at S430, that no free memory locations of a memory block associated with Partition 1 exist. A new memory block 516 is therefore allocated at S435 and a mapping of Record 14 to location 516a is generated at S440, as illustrated in FIG. 5G.

Similarly, during subsequent processing of Record 15, it is determined at S425 that Partition 2 is associated with the key value L and, at S430, that no free memory locations of a memory block associated with Partition 2 exist. Memory block 518 is therefore allocated at S435 and a mapping of Record 15 to location 518a is generated at S440, as illustrated in FIG. 5H.

FIG. 5I depicts mapping of remaining Records 16 and 17 to memory locations based on the above-described flow. After mapping of Record 17, it is determined at S450 that no more assigned records remain to be mapped. Therefore, at S455, each of records 500 is processed and corresponding results are stored in the memory location to which the record maps.

For example, processing of Record 1 may include generating a value based on the values of Record 1 and using the mapping of Record 1 to store the generated value in memory location 512a. Processing of Record 2 may include generating a value based on the values of Record 2 and using the mapping of Record 2 to store the generated value in memory location 514a. In the case of Record 4, a value may be generated based on the values of Record 4. The associated mapping is then used to generate a composite value based on the value already stored in memory location 512a (i.e., due to the processing of Record 1), and to store the composite value in memory location 512a. According to some embodiments, the key value is a date, and memory location 512a initially stores a value of a Sales field of Record 1. Record 4 shares the same key value (i.e., date), and processing at S455 adds the value of the Sales field of Record 4 to the value currently stored in memory location 512a. As a result, memory location 512a contains a running total of the Sales field for all records having the same data as key value.

At the conclusion of S455, the memory locations of memory area 510 include intermediate results associated with each key value, as shown in FIG. 5J. Also and advantageously, results associated with particular partitions are grouped together, which may enable a cache-efficient next processing step.

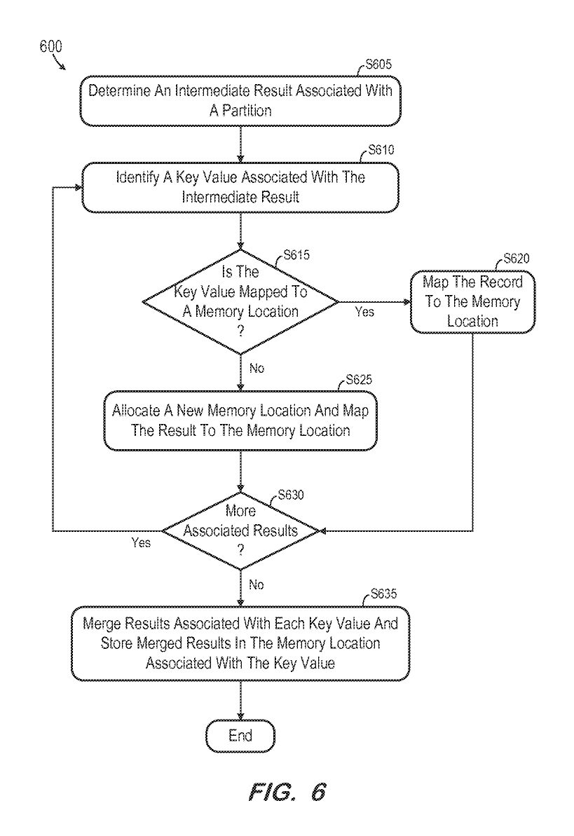

FIG. 6 is a flow diagram of process 600 to perform such next processing according to some embodiments. Process 600 may be performed by two or more processing units independently and in parallel. In some embodiments, the output of process 400 as executed by an execution thread (e.g., memory area 510 of FIG. 5J) resides in a shared memory, as do similar outputs of process 400 as executed by other execution threads with respect to different sets of assigned records.

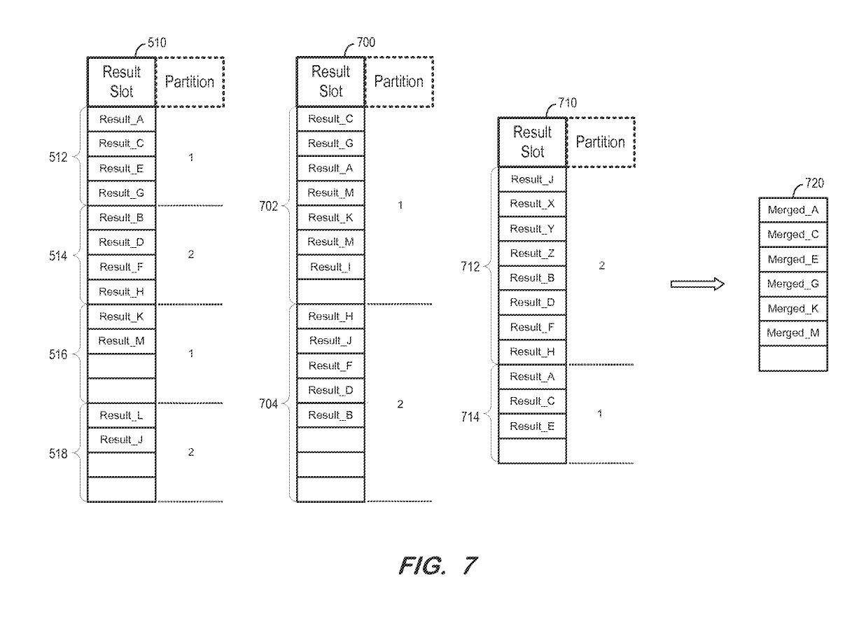

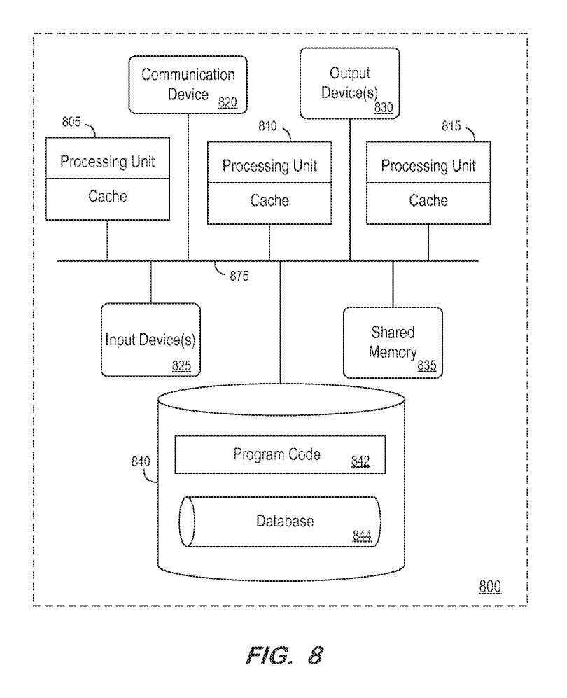

FIG. 7 illustrates such output according to some embodiments. Memory area 510 is shown as described above at the conclusion of one thread's execution of process 400. Memory areas 700 and 710 show the output of other execution threads with respect to records which were different from those use to generate the output shown in memory area 510. Memory areas 510, 700 and 710 may reside in shared memory. The three different outputs may have been generated substantially simultaneously by three different processing units. As shown, the sizes of allocated memory blocks may differ according to some embodiments.

Turning to process 600, an intermediate result associated with a partition is determined at S605. S605 is intended to ensure that the current processing unit operates only on results which are associated with a same partition. This allows other processing units to simultaneously operate on results which are associated with other partitions. For purposes of the present example, it will be assumed that the intermediate results stored in memory blocks 512, 516, 702 and 714 are associated with Partition 1 and the intermediate results stored in memory blocks 514, 518, 704 and 712 are associated with Partition 2.

The first intermediate result of block 512 may be determined at S605, and its key value (i.e., “A”) may be determined at S610. It is then determined whether a result associated with this key value has been mapped to a memory location for storing a merged result associated with this key value. If not, as in the present example, a new memory location is allocated and the intermediate result is mapped to the new memory location.

Flow proceeds through S630 and returns to S605 to determine another intermediate result. Flow therefore continues through S605 to S630 to allocate new memory locations and map intermediate results to the new memory locations if key values associated with the results have not yet been mapped to a memory location for storing a merged result, and to simply map intermediate results to appropriate memory locations if key values associated with the results have already been mapped to a memory location for storing a merged result.

After all intermediate results associated with the partition have been mapped to a memory location, the results are merged at S635. As illustrated by memory area 720 of FIG. 7, the results associated with each key value are merged and then stored in the memory location which was allocated for that key value. As described above, the contiguous storage of intermediate results associated with a given partition increases the efficiency with which the results can be merged.

FIG. 8 is a block diagram of a computing device, system, or apparatus 800 that may be operate as described above. System 800 may include a plurality of processing units 805, 810, and 815 including on-board cache memory. The processing units may comprise one or more commercially available Central Processing Units (CPUs) in the form of one-chip, single-threaded microprocessors, one-chip multi-threaded microprocessors or multi-core multi-threaded processors. System 800 may also include a local cache memory associated with each of the processing units 805, 810, and 815 such as RAM memory modules.

Communication device 820 may be used to communicate, for example, with one or more devices and to transmit data to and receive data from these devices. System 800 further includes an input device 825 (e.g., a mouse and/or keyboard to enter content) and an output device 830 (e.g., a computer monitor to display a user interface element).

Processing units 805, 810, and 815 communicate with shared memory 835 via system bus 875. Shared memory 835 may store intermediate results as described above, for retrieval by any of processing units 805, 810, and 815. System bus 875 also provides a mechanism for processing units 805, 810, and 815 to communicate with storage device 840. Storage device 840 may include any appropriate non-transitory information storage device, including combinations of magnetic storage devices (e.g., a hard disk drive), a CD-ROM, a DVD-ROM, a Flash drive, and/or semiconductor memory devices for storing data and programs.

Storage device 840 may store processor-executable program code 845 independently executable by processing units 805, 810, and 815 to cause system 800 to operate in accordance with any of the embodiments described herein. Program code 845 and other instructions may be stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

In some embodiments, storage device 840 includes database 855 storing data as described herein. Database 855 may include relational row-based data tables, column-based data tables, and other data structures (e.g., index hash tables) that are or become known.

System 800 represents a logical architecture for describing some embodiments, and actual implementations may include more, fewer and/or different components arranged in any manner. The elements of system 800 may represent software elements, hardware elements, or any combination thereof. For example, system 800 may be implemented using any number of computing devices, and one or more processors within system 800 may execute program code to cause corresponding computing devices to perform processes described herein.

Generally, each logical element described herein may be implemented by any number of devices coupled via any number of public and/or private networks. Two or more of such devices may be located remote from one another and may communicate with one another via any known manner of network(s) and/or via a dedicated connection.

Embodiments described herein are solely for the purpose of illustration. Those in the art will recognize other embodiments may be practiced with modifications and alterations to that described above.

What is claimed is:

1. A system comprising:
a storage device storing a plurality of data records, each of the plurality of data records associated with one of a plurality of key values;
a processor; and
a memory storing processor-executable program code executable by the processor to cause the system to:
determine a first plurality of the plurality of data records assigned to a first processing unit;
identify a first record of the first plurality of data records, the first record associated with a first key value;
determine a first partition based on the first key value;
allocate a first memory block associated with the first partition, the first memory block comprising a first two or more memory locations;
generate a mapping between the first record and a first one of the first two or more memory locations;
identify a second record of the first plurality of data records, the second record associated with a second key value;
determine the first partition based on the second key value; and
generate a mapping between the second record and a second one of the first two or more memory locations.

2. A system according to claim 1, the processor-executable program code executable by the processor to cause the system to:
identify a third record of the first plurality of data records, the third record associated with a third key value;
determine a second partition based on the third key value;
allocate a second memory block associated with the second partition, the second memory block comprising a second two or more memory locations; and
generate a mapping between the third record and a first one of the second two or more memory locations.

3. A system according to claim 2, the processor-executable program code executable by the processor to cause the system to:
determine that all memory locations of memory blocks associated with the first partition are mapped to records associated with key values which are different from the first key value; and
determine that all memory locations of memory blocks associated with the second partition are mapped to records associated with key values which are different from the third key value,
wherein the first memory block is allocated in response to the determination that all memory locations of memory blocks associated with the first partition are mapped to records associated with key values which are different from the first key value, and
wherein the second memory block is allocated in response to the determination that all memory locations of memory blocks associated with the second partition are mapped to records associated with key values which are different from the third key value.

4. A system according to claim 2, wherein a size of the first memory block is different from a size of the second memory block.

5. A system according to claim 1, the processor-executable program code executable by the processor to cause the system to:
identify a third record of the first plurality of data records, the third record associated with the first key value; and
generate a mapping between the third record and the first one of the first two or more memory locations.

6. A system according to claim 5, wherein the program code is further executable by the processor to cause the system to:
process the first record and store a result of the processing of the first record in the first one of the first two or more memory locations based on the mapping between the first record and the first one of the first two or more memory locations;
process the second record and store a result of the processing of the second record in the second one of the first two or more memory locations based on the mapping between the second record and the second one of the first two or more memory locations; and
process the third record and store a result of the processing of the third record in the first one of the first two or more memory locations based on the mapping between the third record and the first one of the first two or more memory locations.

7. A system according to claim 1, the processor-executable program code executable by the processor to cause the system to:
determine that all memory locations of memory blocks associated with the first partition are mapped to records associated with key values which are different from the first key value,
wherein the first memory block is allocated in response to the determination that all memory locations of memory blocks associated with the first partition are mapped to records associated with key values which are different from the first key value.

8. A system according to claim 1, wherein the program code is further executable by the processor to cause the system to:
process the first record and store a result of the processing of the first record in the first one of the first two or more memory locations based on the mapping between the first record and the first one of the first two or more memory locations; and
process the second record and store a result of the processing of the second record in the second one of the first two or more memory locations based on the mapping between the second record and the second one of the first two or more memory locations.

9. A system according to claim 1, wherein the program code is further executable by the processor to cause the system to:
determine a second plurality of the plurality of data records assigned to a second processing unit;
identify a first record of the second plurality of data records, the first record associated with a third key value;
determine the first partition based on the third key value;
allocate a second memory block associated with the first partition, the second memory block comprising a second two or more memory locations;
generate a mapping between the first record of the second plurality of data records and a first one of the second two or more memory locations;
identify a second record of the second plurality of data records, the second record associated with a second key value;
determine the first partition based on the second key value; and
generate a mapping between the second record and a second one of the second two or more memory locations.

10. A system comprising:
a storage device storing a plurality of data records, each of the plurality of data records associated with one of a plurality of key values;
a processor; and
a memory storing processor-executable program code executable by the processor to cause the system to:
determine a first plurality of the plurality of data records assigned to a first processing unit;
identify a first record of the first plurality of data records, the first record associated with a first key value;
determine a first partition based on the first key value;
allocate a first memory block associated with the first partition, the first memory block comprising a first two or more memory locations;
generate a mapping between the first record and a first one of the first two or more memory locations;
identify a second record of the first plurality of data records, the second record associated with a second key value;
determine a second partition based on the second key value;
allocate a second memory block associated with the second partition, the second memory block comprising a second two or more memory locations; and
generate a mapping between the second record and a first one of the second two or more memory locations.

11. A system according to claim 10, the processor-executable program code executable by the processor to cause the system to:
determine that all memory locations of memory blocks associated with the first partition are mapped to records associated with key values which are different from the first key value; and
determine that all memory locations of memory blocks associated with the second partition are mapped to records associated with key values which are different from the second key value,
wherein the first memory block is allocated in response to the determination that all memory locations of memory blocks associated with the first partition are mapped to records associated with key values which are different from the first key value, and
wherein the second memory block is allocated in response to the determination that all memory locations of memory blocks associated with the second partition are mapped to records associated with key values which are different from the second key value.

12. A system according to claim 10, wherein a size of the first memory block is different from a size of the second memory block.

13. A system according to claim 10, wherein the program code is further executable by the processor to cause the system to:
determine a second plurality of the plurality of data records assigned to a second processing unit;
identify a first record of the second plurality of data records, the first record associated with a third key value;
determine the first partition based on the third key value;
allocate a third memory block associated with the first partition, the third memory block comprising a third two or more memory locations;
generate a mapping between the first record of the second plurality of data records and a first one of the third two or more memory locations;
identify a second record of the second plurality of data records, the second record associated with a fourth key value;
determine the second partition based on the fourth key value; and
allocate a fourth memory block associated with the second partition, the fourth memory block comprising a fourth two or more memory locations; and
generate a mapping between the second record of the second plurality of data records and a first one of the fourth two or more memory locations.

14. A system according to claim 10, wherein the program code is further executable by the processor to cause the system to:
process the first record and store a result of the processing of the first record in the first one of the first two or more memory locations based on the mapping between the first record and the first one of the first two or more memory locations; and
process the second record and store a result of the processing of the second record in the second one of the first two or more memory locations based on the mapping between the second record and the second one of the first two or more memory locations.

15. A computer-implemented method comprising:
determining, from a plurality of data records, each of the plurality of data records associated with one of a plurality of key values, a first plurality of data records assigned to a first processing unit;
identifying a first record of the first plurality of data records, the first record associated with a first key value;
determining a first partition based on the first key value;
allocating a first memory block associated with the first partition, the first memory block comprising a first two or more memory locations;
generating a mapping between the first record and a first one of the first two or more memory locations;
identifying a second record of the first plurality of data records, the second record associated with a second key value;
determining the first partition based on the second key value; and
generating a mapping between the second record and a second one of the first two or more memory locations.

16. A method according to claim 15, further comprising:
identifying a third record of the first plurality of data records, the third record associated with a third key value;
determining a second partition based on the third key value;
allocating a second memory block associated with the second partition, the second memory block comprising a second two or more memory locations; and
generating a mapping between the third record and a first one of the second two or more memory locations.

17. A method according to claim 16, further comprising:
determining that all memory locations of memory blocks associated with the first partition are mapped to records associated with key values which are different from the first key value; and
determining that all memory locations of memory blocks associated with the second partition are mapped to records associated with key values which are different from the third key value,
wherein the first memory block is allocated in response to the determination that all memory locations of memory blocks associated with the first partition are mapped to records associated with key values which are different from the first key value, and
wherein the second memory block is allocated in response to the determination that all memory locations of memory blocks associated with the second partition are mapped to records associated with key values which are different from the third key value.

18. A method according to claim 16, wherein a size of the first memory block is different from a size of the second memory block.

19. A method according to claim 15, further comprising:
determining that all memory locations of memory blocks associated with the first partition are mapped to records associated with key values which are different from the first key value,
wherein the first memory block is allocated in response to the determination that all memory locations of memory blocks associated with the first partition are mapped to records associated with key values which are different from the first key value.

20. A method according to claim 15, further comprising:
determining a second plurality of the plurality of data records assigned to a second processing unit;
identifying a first record of the second plurality of data records, the first record associated with a third key value;
determining the first partition based on the third key value;
allocating a second memory block associated with the first partition, the second memory block comprising a second two or more memory locations;
generating a mapping between the first record of the second plurality of data records and a first one of the second two or more memory locations;
identifying a second record of the second plurality of data records, the second record associated with a second key value;
determining the first partition based on the second key value; and
generating a mapping between the second record and a second one of the second two or more memory locations.
